(19) United States
(12) Patent Application Publication
(10) Pub. No.: US 2017/0032576 A1
(43) Pub. Date: Feb. 2, 2017

(54) MAN-MACHINE INTERFACE FOR MANAGING THE FLIGHT OF AN AIRCRAFT

(71) Applicant: THALES, COURBEVOIE (FR)

(72) Inventors: Patrick MAZOYER, TOULOUSE (FR); Antoine LACOMBE, TOULOUSE (FR)

(21) Appl. No.: 15/220,718

(22) Filed: Jul. 27, 2016

(30) Foreign Application Priority Data
Jul. 31, 2015 (FR) 1501640

(51) Int. Cl. G06T 19/00; G02B 27/01; G06F 3/0482; G06F 3/0488; B64D 43/00; G06F 3/01

(52) U.S. Cl. CPC G06T 19/006; B64D 43/00; G06F 3/013; G06F 3/0482; G06F 3/0488; G02B 27/0179; G02B 27/0101; G02B 2027/0183; G02B 2027/014

(57) ABSTRACT

A method for managing the flight of an aircraft comprises the steps of determining a flight context; selecting, as a function of the flight context determined, one or more display parameters and displaying one or more graphically selectable labels on a representation of at least one part of the flight of the aircraft, the representation being displayed on at least one screen in the cockpit of the aircraft; receiving indication of the selection of one or more labels and, in response to the selection, modifying the display of the representation of at least one part of the flight of the aircraft. Developments describe the provision of documentary resources, the use of display parameters and/or rules (e.g. sites and priorities). System aspects (e.g. augmented and/or virtual reality for increasing the addressable display area, feedback loop by gaze tracking) as well as software aspects (control of visual density) are described.

### CROSS-REFERENCE TO RELATED APPLICATION

This application claims priority to foreign French patent application No. FR 1501640, filed on Jul. 31, 2015, the disclosure of which is incorporated by reference in its entirety.

### FIELD OF THE INVENTION

The invention relates to the technical field of flight management systems (FMSs) embedded on board aircraft, and in particular to the field of man-machine interfaces for the control of these flight management systems.

### BACKGROUND

A Flight Management System (FMS) is an indispensable tool for managing the trajectory of an aircraft.

Navigation tasks being particularly complex for an object flying at high altitude (e.g. with no landmark), the FMS system is itself a complex tool. This complexity is manifested not only by the quantity of information provided by the system, but also by the difficulty experienced by pilots in accessing the right information—and what is more—at the right time.

When the situation of the aircraft is nominal (for example when the automatic pilot is engaged and the FMS is guiding the aircraft), the role of the pilot consists essentially in monitoring the systems and in ensuring that the flight parameters do indeed correspond to those expected. In this situation, the pilot generally has time to search for information in the hundred or so pages of documentation of the FMS, to consider and test alternative routes, to consult maps, etc.

On the other hand, in certain flight situations or contexts, the time may become a decisive criterion: the pilot must be able to access as rapidly as possible any information deemed critical. This constraint can advantageously be taken into account upstream, when designing the system, and more particularly when designing its man-machine interface (MMI).

This MMI design constitutes a genuine challenge since the data are extremely numerous and the operational situations very varied. The cockpit of a modern aeroplane abounds with information destined for the pilot. Moreover, the interface screens are embedded in the cockpit which is a cramped space and these screens are rarely renewed. Although “glass cockpits” have made it possible to attenuate the problem of the dispersion of information (to a certain extent), the number of screens embedded on board is restricted and the number of “embeddable” screens is very limited.

For current avionics systems, when the content of an FMS page exceeds the size of the screen, a page scrolling system (commonly called a “scrollbar”) is implemented. The latter, coupled to a trackball or a pointing system such as a joystick or a mouse or a touch-sensitive interface, allows the pilot to consult information situated anywhere on the page. For example, the pilot can move the part of interest in display window of the screen. Such is the case, for example, for the Flight Plan (F-PLN) page which bundles together information such as the entirety of “flight plan points” or “waypoints” up to the destination, indications of heading and distance to the next waypoint, estimates, for each waypoint, of the transit time at the point, of the speed and altitude or the EFOB (Estimated Fuel On Board) and the wind (in terms of direction and magnitude), of the constraints on speed, altitude and time, the identifier of the airport and of the arrival runway, system messages, and sometimes other elements, such as for example the next objective of the mission (for example on FMS A400M). In the case of a short F-PLN (i.e. with few waypoints), it is relatively easy for the pilot to find his way around since it requires few manipulations on the screen (for example involving scrolling operations). On the other hand, for long flights, the F-PLN can contain up to 250 waypoints on modern FMSs; knowing that an F-PLN page can display a maximum of 9 waypoints, the cognitive burden very quickly becomes problematic for the pilot searching for a particular waypoint. The latter generally navigates by successive approximations (in the absence of a search function on current FMSs), resorting in particular to very many operations of scrolling and selections on the screen (the majority of the information is masked by default and necessitates several successive operations in order to be readable). This activity is time-consuming and laborious and constitutes an opportunity cost by not allowing the pilot to delve more deeply into his knowledge of the interorganization of the waypoints.

The patent literature does not provide any satisfactory solutions to the technical problem consisting in effectively navigating in significant databases by means of man-machine interfaces with limited characteristics.

### SUMMARY OF THE INVENTION

There is disclosed a method for managing the flight of an aircraft comprising the steps consisting in determining a flight context; selecting, as a function of the flight context determined, one or more display parameters and displaying one or more graphically selectable labels on a representation of at least one part of the flight of the aircraft, the said representation being displayed on at least one screen in the cockpit of the aircraft; receiving indication of the selection of one or more labels and, in response to the said selection, modifying the display of the representation of at least one part of the flight of the aircraft. Developments describe the provision of documentary resources, the use of display parameters and/or rules (e.g. sites and priorities). System aspects (e.g. augmented and/or virtual reality for increasing the addressable display area, feedback loop by gaze tracking) as well as software aspects (control of visual density) are described.

In one embodiment of the invention, the method is implemented within a flight management system of FMS type. Data are extracted from the F-PLN and then stored in a dedicated database. As a function of the display preferences—statically predefined (by the pilot and/or the airline) and/or or dynamically determined (in particular according to the flight context)—a representation of the flight of the aircraft is displayed and accompanied by clickable (or selectable) labels and/or symbols. In response to one or more selections of the said labels and/or symbols, the display is modified. Independently of these selections, the data are updated at regular intervals and the display is refreshed. Stated otherwise, the data extraction, storage, and display mechanisms are relaunched repeatedly over time so as to take account of possible changes occurring during the flight of the aircraft, thus affording the pilot a guarantee of the validity of the information displayed on the representation of the flight.

Advantageously, the parameters of the flight are accessible in a fast, clear and concise manner during the entire flight of the aircraft.

Advantageously, the invention makes it possible to “condense” the representation and the access to a large amount of information on a screen of reduced size. Stated otherwise, the information “density” can be increased (increase in the quantity of information represented per unit display area).

Advantageously, in combination with other embodiments of the invention, the addition of one or more specific effects or visual renderings allows the pilot to view the flight information clearly and in an intuitive manner.

Advantageously the method according to the invention allows synthesis and fast access to the information for pilots. In one embodiment, the accessibility to the information can be maintained in a constant manner. Advantageously, the method according to the invention makes it possible to maintain the “awareness of the situation” of the pilot at a high level (for example without needing to regularly scan through the whole of the F-PLN).

Advantageously, the display can be “distributed” within the cockpit: the diverse screens present in the cockpit, depending on whether or not they are accessible, can be turned to account to distribute the information which is to be displayed. Moreover, augmented and/or virtual reality means can increase the display areas. Increasing the available display area does not invalidate the control of the display density allowed by the invention, via the display of one or more graphically selectable labels. On the contrary, the (contextual) reconfiguration of the display compounding this increase in the addressable display area and control of the visual density (e.g. contextual concentration or densification) allows a considerable improvement in man-machine interaction.

Advantageously, the examples described facilitate the man-machine interactions and in particular unburden the pilot of sometimes repetitive and often complex tedious manipulations, by the same token improving his ability to concentrate on actual piloting. Defining a novel man-machine interaction model, the pilot's visual field can be used to its best and in a more intensive manner, making it possible to maintain a high attention level or to utilize the latter to its best. The cognitive effort to be provided is optimized, or more exactly partially reallocated to cognitive tasks that are more useful in regard to the piloting objective. Stated otherwise, the technical effects related to certain aspects of the invention correspond to a reduction in the cognitive burden of the user of the man-machine interface.

Advantageously, the invention can apply in the avionic or aeronautical context (including the remote piloting of drones) and also in the automotive, maritime or railway transport contexts.

### BRIEF DESCRIPTION OF THE DRAWINGS

Various aspects and advantages of the invention will become apparent in support of the description of a preferred but nonlimiting mode of implementation of the invention, with reference to the figures hereinbelow:

FIG. 1 illustrates the overall technical environment of the invention;

FIG. 2 schematically illustrates the structure and the functions of a flight management system of known FMS type;

FIG. 3 illustrates an exemplary representation of the flight plan according to an embodiment of the invention;

FIG. 4 illustrates an exemplary configuration of the display preferences according to an embodiment of the invention;

FIG. 5 shows examples of steps of the method according to an embodiment of the invention;

FIG. 6 illustrates an exemplary system according to a variant of the invention.

### DETAILED DESCRIPTION

Certain technical terms and environments are defined hereinafter.

The acronym (or initials) FMS corresponds to the conventional terminology “Flight Management System” and refers to the flight management systems of aircraft, known in the state of the art through the international standard ARINC 702. During the preparation of a flight or during a rerouting, the crew inputs various items of information relating to the progress of the flight, typically by using an FMS aircraft flight management device. An FMS comprises input means and display means, as well as computation means. An operator, for example the pilot or the copilot, can input via the input means information such as RTAs, or “waypoints”, associated with route points, that is to say points vertically in line with which the aircraft must pass. These elements are known in the state of the art through the international standard ARINC 424. The computation means make it possible notably to compute, on the basis of the flight plan comprising the list of waypoints, the trajectory of the aircraft, as a function of the geometry between the waypoints and/or altitude and speed conditions.

Hereinafter in the document, the acronym FMD is used to refer to the textual display of the FMS present in the cockpit, generally disposed head-down (at the level of the pilot's knees). The FMD is organized into “pages” which are functional groupings of coherent information. Among these pages feature the “FPLN” page which presents the list of elements of the flight plan (waypoints, markers, pseudo waypoints) and the “DUPLICATE” page which presents the results of the navigation database searches.

The acronym ND is used to refer to the graphical display of the FMS present in the cockpit, generally disposed at head level, i.e. in front of the face. This display is defined by a reference point (centred or at the bottom of the display) and a range, defining the size of the display zone.

The acronym MMI corresponds to Man-Machine Interface (or HMI for HumanMachine Interface). The inputting of the information, and the display of the information input or computed by the display means, constitute such a man-machine interface. Generally, the MMI means allow the flight plan information to be input and consulted.

There is disclosed a method implemented by computer for managing the flight of an aircraft comprising the steps consisting in determining a flight context of the aircraft; selecting, as a function of the flight context determined, one or more display parameters from among predefined parameters and displaying one or more graphically selectable labels on a representation of at least one part of the flight of the aircraft, the said representation being displayed on at least one screen in the cockpit of the aircraft; receiving indication of the selection of one or more labels and, in response to the said selection, modifying the display of the representation of at least one part of the flight of the aircraft.

In a development, the step consisting in determining the flight context comprises one or more steps from among the steps consisting in determining information associated with the state of the systems of the aircraft and/or determining information associated with the environment of the aircraft and/or in applying predefined logic rules to the said determined information.

In a development, the step consisting in determining the flight context comprises the step consisting in receiving or detecting one or more events chosen from among a sequencing of flight plan points, a change of active leg, a revision of the flight plan, the introduction of a hold command or the reception of an air traffic control clearance.

In a development, the flight context is declared by the pilot.

In a development, the flight context is determined repeatedly over time.

In a development, the method furthermore comprises the step consisting in providing a link to a documentary resource in relation to a selected label.

In a development, the method furthermore comprises the step consisting in displaying the said documentary resource.

In a development, the display parameters are configurable.

In a development, the display parameters are configured by the pilot or the airline.

In a development, the display parameters are determined by the application of display rules predefined as a function of the flight context determined, the said rules comprising display placement rules and/or display priority rules.

One and the same flight context can give rise to various behaviours of the display. This intermediate control can be done by applying rules (which are generally predefined and static but which may be dynamically configurable, for example remotely).

Placement rules can govern the distribution of the real displays (screens and or image projections) and/or virtual displays (the corresponding system aspects for real/virtual fusion are described hereinafter).

The display priorities may be different, depending on minimum and/or maximum durations, display elements be associated with a display status permanently, intermittently, in a regular or irregular manner, of optional and replaceable status, precise display parameters (luminance, area, etc).

In a development, the display rules are determined as a function of the visual density of the displayed information destined for the pilot.

In a particular embodiment, a “feedback” loop (for example in the form of a camera capturing the subjective visual point of view of the pilot and/or of a gaze tracking device) makes it possible to modulate or to regulate or to influence the placement rules and/or the display priority rules.

In a development, the representation of at least one part of the flight of the aircraft is three-dimensional.

In a development, a part of the flight of the aircraft corresponds to a flight phase or to a leg.

There is disclosed a computer program product, comprising code instructions making it possible to perform one or more of the steps of the method when the said program is executed on a computer.

There is disclosed a system comprising means for implementing one or more of the steps of the method.

In a development, the system comprises at least one display screen of a flight management system FMS, chosen from among a PFD flight screen and/or an ND/VD navigation screen and/or an MFD multifunction screen.

In a development, the system comprises a display screen of an Electronic Flight Bag.

In a development, the system comprises augmented reality and/or virtual reality means.

The display means can comprise, in addition to the screens of the FMS, an opaque virtual reality headset and/or a semi-transparent augmented reality headset or a headset with configurable transparency, projectors (pico-projectors for example, or videoprojectors to project the simulation scenes) or else a combination of such apparatuses. The headset can therefore be a “head-mounted display”, a “wearable computer”, “glasses”, a video-headset, etc. The displayed information may be entirely virtual (displayed in the individual headset), entirely real (for example projected onto the plane surfaces available in the real environment of the cockpit) or a combination of the two (in part a virtual display superimposed on or fused with reality and in part a real display via projectors).

The means AR comprise, in particular, systems of HUD (“Head Up Display”) type and the means VR comprise, in particular, systems of EVS (“Enhanced Vision System”) or SVS (“Synthetic Vision System”) type.

The visual information can be distributed or apportioned or projected or masked as a function of the pilot's immersive visual context. This “distribution” can lead to the pilot's environment being considered in an opportunistic manner by considering all the available surface areas so as to add (overlay, superimpose) virtual information, chosen in an appropriate manner in their nature (what to display), temporality (when to display, at what frequency) and site (priority of the displays, stability of the sites, etc). At one extreme, all the hardly used or slightly used sites in the environment of the user can be utilized to densify the information display. Further still, by projecting image masks overlaid on the real objects, the display can “erase” one or more control instruments physically present in the cockpit (handles, buttons, actuators) whose geometry is known and stable so as to increase the addressable areas still further. The real environment of the cockpit can therefore find itself transformed into as many “potential” screens, or indeed into a single unified screen.

In one embodiment, the reconfiguration of the screen according to the invention is “disengageable”, i.e. the pilot can decide to cancel or to deactivate all the modifications of the display in progress so as to rapidly return to the “nominal” display mode, i.e. standard without the display modifications. The reconfiguration mode can for example be exited by voice command (passphrase) or via an actuator (deactivation button). Various events can trigger this hasty exit from the graphical reconfigurations in progress (for example “sequencing” of a waypoint, a change of flight phase, the detection of a major anomaly such as an engine fault, depressurization, etc).

In a development, the system comprises exclusively interface means of touch-sensitive type. In a particular embodiment of the invention, the cockpit is entirely touch-sensitive, i.e. consists exclusively of MMI interfaces of touch-sensitive type. Indeed, the methods and systems according to the invention allow “all-touch-sensitive” embodiments, that is to say according to a man-machine interaction environment consisting entirely of touchscreens, without any tangible actuator but advantageously entirely reconfigurable.

In a development, the system furthermore comprises means for acquiring images of the cockpit (e.g. interpretation or reinjection of data by OCR and/or image recognition—by “scraping”—, camera mounted on a headset worn by the pilot or fixed camera at the rear of the cockpit) and/or a gaze tracking device.

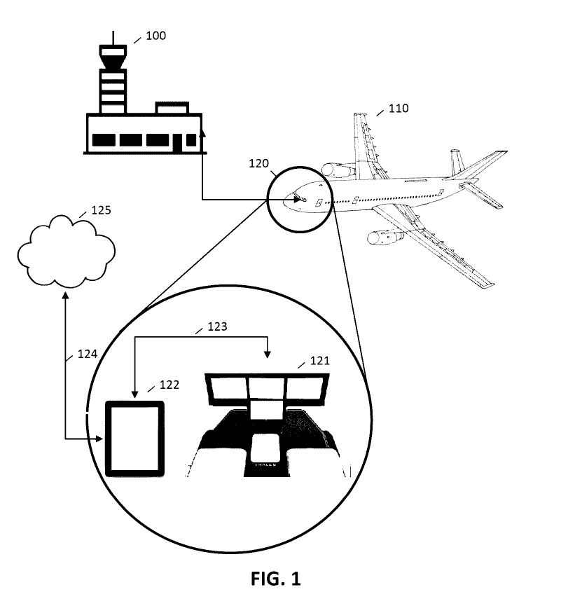

FIG. 1 illustrates the overall technical environment of the invention. Avionics equipment or airport means 100 (for example a control tower linked up with the air traffic control systems) are in communication with an aircraft 110. An aircraft is a transport means capable of moving around within the terrestrial atmosphere. For example, an aircraft can be an aeroplane or a helicopter (or else a drone). The aircraft comprises a flight cabin or a cockpit 120. Situated within the cockpit is piloting equipment 121 (termed avionics equipment), comprising for example one or more onboard computers (means of computing, saving and storing data), including an FMS, means of displaying or viewing and inputting data, communication means, as well as (optionally) haptic feedback means and a taxiing computer. A touch-sensitive tablet or an EFB 122 may be situated aboard, in a portable manner or integrated into the cockpit. The said EFB can interact (bilateral communication 123) with the avionics equipment 121. The EFB can also be in communication 124 with external computing resources, accessible through the network (for example cloud computing 125). In particular, the computations can be performed locally on the EFB or partially or totally in the computation means accessible through the network. The onboard equipment 121 is generally certified and regulated while the EFB 122 and the connected computing means 125 are generally not (or to a lesser extent). This architecture makes it possible to inject flexibility on the EFB 122 side while ensuring controlled safety on the onboard avionics 121 side.

Among the onboard equipment there feature various screens. The ND screens (graphical display associated with the FMS) are generally disposed in the primary field of view, at “head-level”, while the FMDs are positioned “head-down”. The set of information entered or computed by the FMS is grouped together on so-called FMD pages. Existing systems make it possible to navigate from page to page, but the size of the screens and the necessity of not placing too much information on a page for the readability thereof do not allow a summary overall assessment of the current and future situation of the flight. The cabin crews of modern aeroplanes generally consist of two people, distributed on either side of the cabin: a “pilot” side and a “copilot” side. Business aeroplanes sometimes have just a pilot, and certain older aeroplanes or military transport aeroplanes have a crew of three people. Each views on his MMI the pages of interest to him. Two pages from among the hundred or so possible are generally displayed permanently during the execution of the mission: the “flight plan” page first, which contains the information about the route followed by the aeroplane (list of the next waypoints with their associated predictions in terms of distance, time, altitude, speed, fuel, wind). The route is divided into procedures, themselves consisting of points (as described by patent FR2910678) and the “performance” page thereafter, which contains the useful parameters for guiding the aeroplane over the short term (speed to be followed, altitude ceilings, next changes of altitude). There also exists a multitude of other pages available onboard (the lateral and vertical revision pages, the information pages, pages specific to certain aircraft), i.e. generally a hundred or so pages.

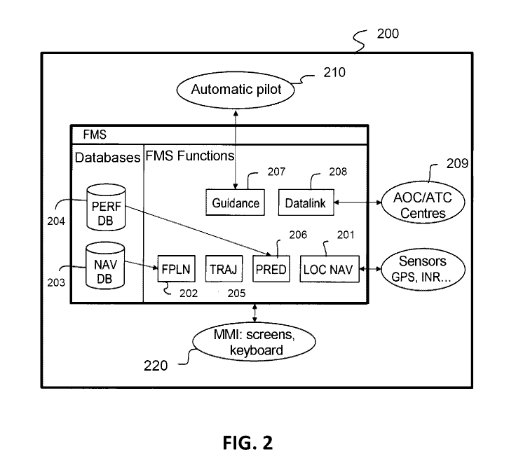

FIG. 2 schematically illustrates the structure and the functions of a flight management system of known FMS type. A system of FMS type 200 disposed in the cockpit 120 and the avionic means 121 has a man-machine interface 220 comprising inputting means, for example composed of a keyboard, and display means, for example composed of a display screen, or else simply a touch-sensitive display screen, as well as at least the following functions:

Navigation (LOCNAV) 201, for performing the optimal location of the aircraft as a function of the geolocation means such as satellite-based or GPS or GALILEO geopositioning, VHF radionavigation beacons and inertial platforms. This module communicates with the aforementioned geolocation devices;

Flight plan (FPLN) 202, for inputting the geographical elements constituting the “skeleton” of the route to be followed, such as the points imposed by the departure and arrival procedures, the routing points and the airways. An FMS generally hosts several flight plans (the so-called “Active” flight plan on which the aeroplane is guided, the “temporary” flight plan making it possible to perform modifications without activating the guidance on this flight plan and (so-called “secondary”) “inactive” work flight plans;

Navigation database (NAVDB) 203, for constructing geographical routes and procedures with the help of data included in the bases relating to the points, beacons, interception legs or altitude legs, etc;

Performance database (PERFDB) 204, containing the craft's aerodynamic and engine parameters;

Lateral trajectory (TRAJ) 205, for constructing a continuous trajectory on the basis of the points of the flight plan, complying with the performance of the aircraft and the confinement constraints (RNAV for Area Navigation or RNP for Required Navigation Performance);

Predictions (PRED) 206, for constructing an optimized vertical profile on the lateral and vertical trajectory and giving the estimations of distance, time, altitude, speed, fuel and wind notably at each point, at each change of piloting parameter and at destination, which will be displayed to the crew. The methods and systems described affect or relate to this part of the computer;

Guidance (GUID) 207, for guiding in the lateral and vertical planes of the aircraft on its three-dimensional trajectory, while optimizing its speed, with the aid of the information computed by the Predictions function 206. In an aircraft equipped with an automatic piloting device 210, the latter can exchange information with the guidance module 207;

Digital data link (DATALINK) 208 for exchanging flight information between the Flight plan/Predictions functions and the control centres or the various other aircraft 209;

one or more MMI screens 220.

The set of information entered or computed by the FMS is grouped together on display screens (pages FMD, NTD and PFD, HUD or the like). On A320 or A380 type airliners, the trajectory of the FMS is displayed at head level, on a so-called Navigation Display (ND) display screen. The “Navigation display” offers a geographical picture of the situation of the aircraft, with the display of a cartographic background (whose exact nature, whose appearance and whose content may vary), sometimes together with the flight plan of the aircraft, the characteristic points of the mission (equi-time point, end of climb, start of descent, etc.), the surrounding traffic, the weather in its diverse aspects such as winds, storms, zones of freezing conditions, etc. On aircraft of the A320, A330, A340, B737/747 generation, there is no interactivity with the flight plan display screen. The flight plan is constructed using an alphanumeric keyboard on a so-called MCDU (Multi Purpose Control Display) interface. The flight plan is constructed by inputting the list of “waypoints” represented in tabular form. It is possible to input a certain amount of information about these “waypoints”, via the keyboard, such as the constraints (speed, altitude) that must be complied with by the aircraft on passing the waypoints. This solution presents several defects. It does not make it possible to deform the trajectory directly: it is necessary to undertake a successive inputting of “waypoints”, which either exist in the navigation databases (NAVDB standardized onboard in the AEEC ARINC 424 format), or are created by the crew via its MCDU (by inputting coordinates for example). This process is tedious and inaccurate having regard to the size of current display screens and their resolution. For each modification (for example a deformation of the trajectory to avoid a dangerous weather vagary, which is moving), it is necessary to re-input a succession of waypoints outside of the zone in question.

On the basis of the flight plan defined by the pilot (list of “waypoints”), the lateral trajectory is computed as a function of the geometry between the waypoints (customarily called LEGs) and/or the altitude and speed conditions (which are used for computing the turning radius). On this lateral trajectory, the FMS optimizes a vertical trajectory (in terms of altitude and speed), passing through possible altitude, speed, time constraints. The set of information entered or computed by the FMS is grouped together on display screens (MFD pages, NTD and PFD, HUD or other visualizations). The MMI part of FIG. 2 therefore comprises a) the MMI component of the FMS which structures the data for dispatch to the display screens (termed CDS for Cockpit Display System) and b) the CDS itself, representing the screen and its graphical piloting software, which performs the display of the drawing of the trajectory, and which also comprises the pilots making it possible to identify the movements of the finger (in the case of a touch-sensitive interface) or of the pointing device.

The set of information entered or computed by the FMS is grouped together on “pages” (displayed graphically on one or more of the screens of the FMS). The existing systems (termed “glass cockpits”) make it possible to navigate from page to page, but the size of the screens and the necessity not to overload the pages (so as to safeguard their readability) do not make it possible to obtain an overview of the current and future situation of the flight. Thus, the search for a particular element of the flight plan can take the pilot a great deal of time, especially if he has to navigate among numerous pages (long duration flight plan). Indeed, the various FMS and screen technologies currently used allow only between 6 and 20 lines and between 4 and 6 columns to be displayed.

The cabin crews of modern aeroplanes consist of two people, distributed on each side of the cabin: a “pilot” side and a “copilot” side. Each one views on their screens the pages of interest to them.

Two pages (out of some hundred possible) are in general displayed permanently during the execution of the mission: on the one hand, the so-called “F-PLN” page which contains the information about the route followed by the aeroplane (e.g. list of the next waypoints with their associated predictions in terms of distance, time, altitude, speed, fuel, wind) and on the other hand the so-called “performance” or “flight progress” page, which contains the useful parameters for guiding the aeroplane over the short term (speed to be followed, altitude ceilings, next changes of altitude).

The entirety of the screens is monopolized by these 2 pages affording a small number of columns, in fact masking the other pages of the FMS which may potentially provide a large quantity of information and certain of which may also allow data to be input by the pilot.

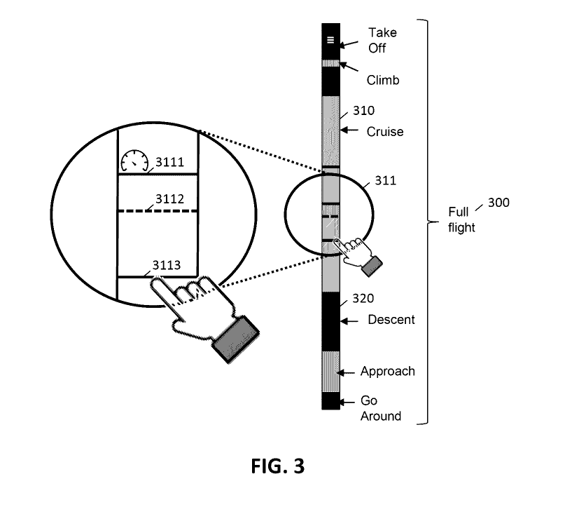

FIG. 3 shows an exemplary representation of the flight of the aircraft according to the invention, this representation being displayed on one or more screens of the FMS.

The representation (of at least one part of the flight of the aircraft) is configurable, according to various modalities. In particular, the representation can be contextual.

In certain embodiments of the invention, the method comprises steps or logical methods making it possible to determine the “flight context” or “current flight context” of the aircraft.

The flight context at a given time incorporates the set of actions taken by the pilots (and in particular the effective piloting setpoints) and the influence of the exterior environment on the aircraft.

A “flight context” comprises for example a situation, such as the position, the flight phase, the waypoints, the procedure in progress (and others), from among predefined or precategorized situations associated with data. For example, the aircraft may be in the approach phase for landing, in the takeoff phase, in the cruising phase but also in the ascent stage, descent stage, etc (a variety of situations may be predefined). Moreover, the current “flight context” may be associated with a multitude of descriptive parameters or attributes (current meteorological state, state of the traffic, status of the pilot comprising for example a stress level such as measured by sensors, etc).

A flight context can therefore also comprise data, for example filtered by priority and/or based on flight phase data, meteorological problems, avionic parameters, ATC negotiations, anomalies related to the status of the flight, problems related to the traffic and/or to the relief. Examples of “flight context” comprise for example contexts such as “cruising regime/no turbulence/nominal pilot stress” or else “landing phase/turbulence/intense pilot stress”. These contexts can be structured according to diverse models (e.g. hierarchized for example as a tree or according to diverse dependencies, including graphs). Categories of contexts can be defined, so as to summarize the needs as regards man-machine interaction (e.g. minimum or maximum interaction lag, minimum and maximum quantity of words, etc). Specific rules may also persist in certain contexts, in particular of emergencies or of critical situations. The categories of contexts may be static or dynamic (e.g. configurable).

The method can be implemented in a system comprising means for determining a flight context of the aircraft, the said determining means comprising, in particular, logic rules which manipulate values such as measured by means of physical measurement. Stated otherwise, the means for determining the “flight context” comprise system means or “hardware” or physical/tangible and/or logic means (e.g. logic rules, for example predefined). For example, the physical means comprise the avionics instrumentation proper (radars, probes, etc) which make it possible to establish factual measurements characterizing the flight. The logic rules represent the set of information processing operations making it possible to interpret (e.g. to contextualize) the factual measurements. Certain values may correspond to several contexts and by correlation and/or computation and/or simulation, it is possible to decide between candidate “contexts”, by means of these logic rules. A variety of technologies makes it possible to implement these logic rules (formal logic, fuzzy logic, intuitionistic logic, etc).

As a function of this context as determined by the method, the method according to the invention can “sensorially” reproduce information whose selection is chosen with care or “intelligence”. Sensory reproduction is understood to mean that the information can be reproduced via various cognitive modes (vision, hearing, haptic feedbacks i.e. touch-sensitive/vibration-sensitive, etc) and/or according to a combination of these modes. A single cognitive sense may be invoked (for example solely via graphical display of the information), but according to certain embodiments, multimode reproduction can be performed (graphical display and simultaneously or asynchronously transmission of vibration via suitable devices, for example on the pilot's wrist). Advantageously, multimode reproduction allows a certain robustness of communication of flight setpoints to pilots. For example, if it is likely that an item of information has not been taken into account, reminders using a different combination of cognitive modes can be performed.

The preselection of flight parameters can be performed by diverse means. By means of predefined rules, the flight parameters that are most relevant as a function of the flight contexts can be selected. Predefined thresholds or ranges of predefined thresholds can be used. Information associated with the selected flight parameters can be displayed, according to the same principles of rules, thresholds and scores. The temporal or sequence aspect of these flight parameters can also be taken into account. In a similar manner, metadata or information complementary to the flight parameters can be provided. According to one aspect of the invention, there is indeed disclosed a method aimed at conferring a “depth of view” in regard to piloting. In a similar manner, information “necessary and sufficient” to explain the flight parameters (for example flight setpoints) can also be reproduced sensorially. Finally, still for example and in a nonlimiting manner, information associated with possible anomalies as regards these flight parameters (or their context) can also be reproduced sensorially.

As a function of the flight context, for example in an emergency situation, it is entirely acceptable to provide information that is quantitatively very reduced. When the situation so allows, such as determined by the set of logic rules governing the man-machine interaction, it will on the other hand be possible to display more information. The invention requires the reproduction of “at least” one of the previously cited items of information. Optionally, the management of the display rules can be supervised or tempered or weighted by applying a “counter” of reproduced flight parameters (i.e. quantitative estimation of the information density).

In an “automated” or “contextual” or “contextualized” embodiment, for example as a function of the flight context, a list of parameters (for example flight parameters) associated with one or more waypoints can be displayed (destined for the pilot), the said parameters being selected as a function of predetermined criteria. For example it will be possible to display pseudos, various types of constraints, airways or procedures.

In an “on-demand” embodiment, for example as a function of his needs, of the flight context or phase, the pilot will be able to choose and access specific information.

In an embodiment combining the “on-demand access” and “contextual access” modes, some information is rendered accessible in a contextual manner by default while certain other information is accessible on request. Various lists and conditions governing these lists can be predefined. The lists and/or conditions can be defined in configuration files, for example read by the FMS during its initialization.

In one embodiment, use is made of graphical symbols (according to a conventional or standardized “symbology”), which are associated with the flight parameters. The various symbols facilitate navigation around the data. In one embodiment, the symbols are inserted (or marked or overlaid or projected) on graphical display objects such as vertical scrollbars for scrolling the content of a page (e.g. with the finger on a touch-sensitive interface or by means of an effector or cursor of mouse or “trackpad” type). In this way, by selecting a symbol, the pilot can access the corresponding information.

In one embodiment, the method according to the invention comprises a mechanism for selecting and/or filtering and displaying characteristics of objects of the flight plan, for example on a vertical scrollbar.

The graphical representation illustrated in FIG. 3 constitutes a temporal overview of the entire duration of the flight of the aircraft 300. In the example of the figure, the graphical representation comprises various sub-parts or segments (e.g. legs), which represent for example the various flight phases (here cruising 310 and descent 320). In the example illustrated, the representation of the flight is carried out in the form of a “scroll” bar (the term “scrolling” connotes the ability to access various steps or phases of the flight in a direct manner as well as the “oriented” or “hierarchized” spatial organization of the graphical representation. The said bar is “navigable” or “interactive” or “rich” or “dynamic”).

Other types of representation are possible, for example in the form of a straight line accompanied by labels, in circular form with indication of direction, in a graphical form complying with the proportionality of the durations of the various flight phases or conducive to the optimization of the information display density etc. In a preferential embodiment, to match screens which are currently of rectangular shape, the scroll bar according to the invention is disposed vertically or horizontally.

In an operational manner, to access the various accessible information indicated by a plurality of labels (for example 3111, 3112 and 3113), the pilot can select with his finger or with the cursor one or more labels of the scroll bar corresponding to an element of interest of the flight so that the F-PLN page is automatically positioned and adjusted (so that the said element is visible and manipulatable). In one embodiment, so as not to overload the display on the scroll bar, the labels can be simple lines (optionally in colour).

In one embodiment, visual rendering effects are triggered automatically so as to improve the readability of the information displayed.

For example, in the case where a number of elements in excess of a predefined threshold are displayed on the scroll bar, certain visual elements may mask others.

In one embodiment, a “magnifying glass” effect can be triggered automatically or on request (for example after pressing a symbol for more than a certain time). Advantageously, this representation of the flight makes it possible to afford an “exploded” view of the region targeted by the cursor, while making it possible to remove possible ambiguities between the various navigation elements and also to avoid selecting the wrong object because of their physical proximity.

Other specific visual rendition alternatives comprise: the highlighting of certain contents and/or their flashing and/or the opening of a complementary display window (on the same screen or on a connected item of equipment such as an EFB) and/or the audio enunciation of the corresponding textual content and/or the concomitant reduction of the other information displayed and/or the rearrangement of the information displayed.

In one embodiment, clicking on a symbol or a designated portion (or a similar operation, such as a touch-based or gestural or verbal designation) scrolls the F-PLN to the desired site.

The labels placed on the scroll bar (for example 3111, 3112 and 3113), can be accompanied and/or displayed in various colours. These labels or symbols can be of hyperlink type so as to allow fast access to pages affording more detailed information on the elements concerned.

In certain embodiments, the various phases of the flight can be displayed in a contrasted manner (cruising phase 310 in light grey, descent phases 320 in dark grey, etc.).

The labels can also be accompanied by symbols (described hereinafter).

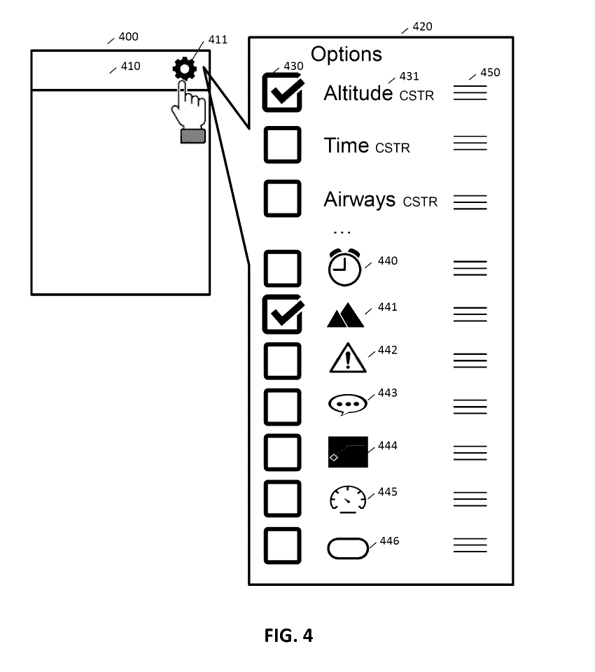

FIG. 4 illustrates the (optional) configuration of the display parameters according to the invention.

The configuration or the parametrization of the display can for example be accessible by way of a clickable icon 311 displayed in a menu 310 of a page 300 of an FMS. By clicking on the settings icon 311, the pilot will be able to choose to select certain information, which can be brought to the fore (i.e. displayed in a priority manner) and/or be displayed alone (display “layer” or “overlay”). In the example illustrated, the pilot selects 431 the altitude parameter 430 (by cursor or by touch-input). In a variant embodiment, the attitude parameter is represented by a symbol: the pilot may (or may not) select the altitude constraints symbol 441.

The displayed information relates to elements that are unique or rather few in the FPLN. For example, the altitude parameter 430 is a constrained (“CSTR”) parameter. This does not entail filtering according to a parameter which would in general be the altitude but entails displaying specific and relevant data, for example in regard to the flight context and/or to the user's preferences.

Display priority rules (optional, configured or configurable for example via user and/or airline preferences) allow the pilot to “rank” the information to be displayed that he has chosen so as to give priority of display to the more significant information if necessary. For example, in the case of “cluttering”, the text or the symbol of the priority item of information can be displayed without needing to resort to a zoom effect on the scroll bar. On the contrary, information associated with lower priorities may have their text and/or symbol displayed solely in a magnified view.

The display modalities can therefore be controlled by applying display rules associated with the various elements displayable of the FPLN, these rules taking into account display priorities (absolute or relative i.e. resolving the conflicts between priorities of the same level).

The “anchors” 450 of FIG. 4 afford an optional mechanism for rapidly modifying the priorities between the various elements present in the menu such as illustrated (and more generally for the elements displayed). In one embodiment, lengthy pressing on an anchor without release renders the line concerned repositionable either at the very top or at the very bottom of the list, or at an intermediate position (for example between two other elements of the list). As soon as the button of the mouse or the finger in a touch-sensitive implementation is released by the pilot, the element is positioned at the chosen spot.

Stated otherwise, the pilot can preselect the information that he wishes to see displayed, either exclusively (i.e. in a binary manner) or in a priority manner. The pilot can decide which elements are judicious from among all those available. By selecting or by activating certain display options the pilot can maximize the relevance of the information rendered accessible. In a variant embodiment, the display modalities are preconfigured by the airline. In another variant, the flight context evaluated repeatedly in the course of time dynamically determines the said display modalities.

In one embodiment, the display of the scroll bar can be parametrized. For example, a flying window or “pop-up” can be displayed so as to allow the selection of the elements to be displayed on the scrollbar. Certain elements may be pre-ticked as a function of the company's MMI policy. Certain options cannot be deactivated by the pilot.

In one embodiment, the airline decides a priori on the relevant elements to be shown on the man-machine interface and defines them in a file read by the FMS on startup. These elements, which cannot be modified by the pilot in-flight, respond by design to his operational needs. Advantageously, this solution makes it possible not to compel the pilot himself to tick the elements that he wishes to extract from the list.

In another embodiment, the pilot himself defines, as a function in particular of his present and future needs, of the flight context or of the ATC clearances, the various flight plan elements that he wishes to be able to access rapidly. This customization of the interface makes it possible to feature only the graphical elements meaningful to the pilot, thus guaranteeing better readability of the information. On the other hand, it compels the pilot to modify the settings himself. This customization does not however prevent certain options being activated by default according to the choice of the company.

The labels can also be accompanied by symbols (described hereinafter).

The form of the symbols is generally the discretion of the airlines. Ergonomics or “human factor” studies can be conducted so as to quantify the readability and the clarity of the information as a function of the density of information and symbols adopted. Stated otherwise, the way in which information is represented can have a direct impact on the speed and dependability of decision making in a critical environment such as the piloting of an aircraft. Hence, quantifications (and as a consequence optimizations) based on analysing the arrangements of symbols can allow substantial improvements, including of a technical nature.

FIG. 4 shows several examples of such symbols: time constraint 440, altitude constraint 441, indication of reminder or of danger 442, info-bubble 443, transition symbol 444, speed contrast 445, “hold” 446, etc. It is also possible to represent departure (SID) and arrival (STAR) procedures, pseudo-waypoints (e.g T/C for Top of Climb, etc), ATC clearances (for example by automatically recovering the caption of a waypoint, searching for and positioning a symbol on the scroll bar at the level of this waypoint).

More generally, beyond managing just his F-PLN, the method for modifying the display according to the invention allows the pilot to optimize the functional rendition of the (“navigation”) scroll bar. Stated otherwise, instead of representing the pages of the F-PLN on the scroll bar, it is possible to represent various functions relevant to the pilot. For example, the representation can include the various missions scheduled during the flight (e.g. patterns of refuelling, jettisoning or rescue), which are displayed on the navigation bar. The coexistence of the various information can make it possible to “condense” or to involve “condensing” long distances (e.g. transatlantic cruising), that is to say be conducive to the representation of the succession of events while complying with the proportionality of the distances. “Short” flight zones are generally rich in events (e.g. takeoff, climb, descent, approach and landing).

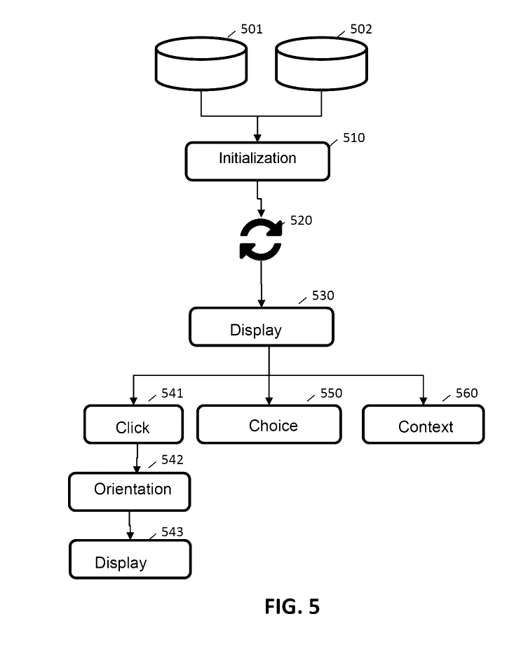

FIG. 5 illustrates examples of steps of the method according to an embodiment of the invention.

The method may for example rely on two databases 501 and 502.

The first database 501 contains the set of symbols displayable on the scroll bar as well as the set of correspondences between the interactions of the pilot with the symbols on the MMIs and the various display management operations. For example, the detection or the reception of a click or of a touch-based input on an altitude constraint symbol will change the orientation of the page (causing for example the page to scroll until the element of interest is obtained positioned at the very top of the page) so that the waypoint on which the said constraint is applied is made visible).

In one embodiment, a list of the relevant elements that the pilot may have to search for during the flight is compiled. For example, as a function of the known flight plan, it may be determined that the pilot will or may need in the F-PLN of the FMS the following pages: flight phase, route, departure or arrival procedure, pseudo-waypoint (Top of Climb, Top of Descent, . . . ), constraint on a waypoint (altitude, speed, time), “Hold” on a waypoint, “Step Alts” (or Cruise Section), a waypoint concerned in an ATC clearance, etc.

The second database 502 relates to the pilot's and/or the airline's choices or options or preferences, possibly influenced by the current flight phase such as determined. In a variant embodiment, the parameters relating to the display preferences are recovered from the previous flight (this typical case will be for example advantageous in the case of private flights, business aviation flights and commercial aviation short-haul turn-arounds).

The two databases 501 and 502 can therefore serve to initialize the method according to the invention in step 510. The method according to the invention determines for example which elements of the F-PLN are overlaid on the scroll bar of the F-PLN page, determines which are the “target” (destination) pages in the data set of the F-PLN and, for example, according to which graphical modalities the various displays have to occur.

In step 520, one or more correspondences between action(s) of the user on the man-machine interface and the modification(s) of display is or are determined. This correspondence can occur according to various modalities. An action can trigger several modifications of displays, on one screen or on several screens. A combination of several actions emanating from the user (concomitance or succession of closely spaced user actions, e.g. in a time interval of less than a certain predefined threshold; for example multi-touch actions) can also trigger one or more modifications of the display, still on one and the same screen or on a plurality of screens. For example, it will be possible to establish correspondences between labels and correspondences in the F-PLN, and then each label will be associated with a hyperlink so as to permit fast access to the data desired upon clicking on the corresponding symbol (the respective graphical positionings will be able to be optimized i.e. determined).

In step 530, the various labels or symbols are displayed in an effective manner on the scroll bar, at the previously determined sites, according to the various modalities of graphical rendition (e.g. magnifying glass mechanism to avoid, if appropriate, congested views of symbols placed too close together, etc).

In step 541, for example, there is received an indication according to which the pilot has selected one or more graphical labels or symbols. The hyperlink determined in step 520 is then invoked, thereby making it possible to identify the target that the pilot desires to consult. In one embodiment, the orientation of the page is then recomputed 542 so as to position the designated element at the top of the page, as may be expected by the pilot. Once the computation has been completed, the page comprising the element of interest is displayed 543.

In step 550, for example, if the pilot is for example so permitted, the list of the elements displayable on the scroll bar can be modified.

In step 560, for example, the flight context can be modified (e.g. modification of the F-PLN, sequencing of a point, recomputation of predictions, change of state of a constraint, etc).

In all cases, the display is continually updated. The data relating to the a) user actions of selection type 541, b) indications of display preference 550 and c) information relating to the context of the flight 560 are re-evaluated repeatedly. These determinations can be performed regularly (e.g. periodically, etc) or irregularly (e.g. aperiodically, intermittently, triggered by flight events, etc).

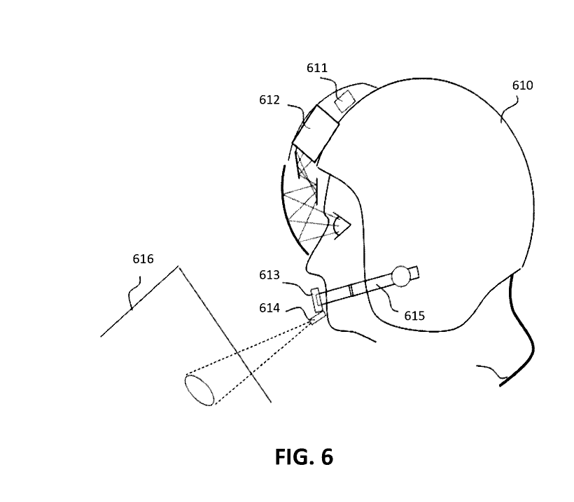

FIG. 6 illustrates various aspects relating to the man-machine interfaces MMI which can be implemented in order to deploy the method according to the invention. As a supplement—or as a substitute—for the screens of the EFB and/or FMS onboard computer, additional MMI means can be used. Generally, FMS avionics systems (which are systems certified by the air regulator and which may exhibit certain limitations in terms of display and/or of ergonomics) may advantageously be complemented with non-avionic means, advanced MMIs in particular.

The representation of at least one part of the flight of the aircraft can be carried out in two dimensions (e.g. display screen) but also in three dimensions (e.g. virtual reality or 3D display on screen). In 3D embodiments, the labels can be selectable zones in space (that can be selected by various means e.g. by virtual reality interfaces, glove, trackball or according to other devices). The three-dimensional display may be complementary to the two-dimensional display within the cockpit (e.g. semi-transparent virtual reality headset, augmented reality headset, etc). If appropriate, diverse forms of representation of the flight are possible, the additional depth dimension being able to be allocated to a time dimension (e.g. duration of the flight) and/or space dimension (e.g. spacing of the various waypoints, physical representation of the trajectory of the aircraft in space, etc). The same variants or variants similar to the 2D case may be implemented: management of information density, placement of labels, appearance and disappearance of symbols, showing of events during the flight, etc.

In particular, the man-machine interfaces can make use of virtual and/or augmented reality headsets. FIG. 6 shows an opaque virtual reality headset 610 (or a semi-transparent augmented reality headset or a headset with configurable transparency) worn by the pilot. The individual display headset 610 can be a virtual reality headset (VR), or an augmented reality headset (AR) or a top sight, etc. The headset can therefore be a “head-mounted display”, a “wearable computer”, “glasses” or a video-headset. The headset can comprise computation and communication means 611, projection means 612, audio acquisition means 613 and video projection and/or video acquisition means 614. In this way, the pilot can—for example by means of voice commands—configure the viewing of the flight plan in three dimensions (3D). The information displayed in the headset 610 can be entirely virtual (displayed in the individual headset), entirely real (for example projected onto the plane surfaces available in the real environment of the cockpit) or a combination of the two (in part a virtual display superimposed or fused with reality and in part a real display via projectors).

The reproduction of information can in particular be performed in a multimode manner (e.g. haptic feedbacks, visual and/or auditory and/or tactile and/or vibratory reproduction).

The display can also be characterized by the application of predefined placement rules and display rules. For example, the man-machine interfaces (or the information) may be “distributed” (segmented into distinct portions, optionally partially redundant, and then apportioned) between the various virtual screens (e.g. 610) and/or real screens (e.g. FMS, TAXI).

The various steps of the scheme can be implemented in all or part on the FMS and/or on one or more EFBs. In a particular embodiment, the whole set of information is displayed on the screens of the FMS alone. In another embodiment, the information associated with the steps of the scheme is displayed on the embedded EFBs alone. Finally, in another embodiment, the screens of the FMS and of an EFB can be used jointly, for by in “distributing” the information among the various screens of the various pieces of kit. Suitably performed spatial distribution of the information can help to reduce the cognitive burden of the pilot and thereby improve decision making and increase flight safety.

According to an optional embodiment of the invention, means for acquiring images (for example a photographic apparatus or a video camera disposed in the cockpit) make it possible to capture at least one part of the set of visual information displayed destined for the pilot (advantageously, this video feedback will be placed on a head-up visor, smartglasses or any other item of equipment worn by the pilot, so as to capture the pilot's subjective view). By image analysis (performed in a fixed regular manner or in a continuous manner in the case of a video capture), the information density is estimated according to the various sub-parts of images and display adjustments are determined dynamically. For example, in the case where a display screen would become too “congested” (quantity of text or of graphical symbols in excess with respect to one or more predefined thresholds), the lowest priority information is “reduced” or “condensed” or “summarized” in the form of labels or symbols which are selectable according to modalities similar to those presently described (placement of the interactive labels on or along a graphical representation of the flight of the aircraft). Conversely, if the displayed information density so allows, information which is reduced or condensed or summarized, for example previously, is developed or detailed or extended or magnified. In one embodiment of the invention, the “visual density” is maintained substantially constant. The flight phase or context can modulate this visual density (for example, on landing or in the critical phases of the flight, the density of information is reduced). According to the embodiments, the visual density can be measured as the number of lit or active pixels per square centimetre, and/or as the number of alphanumeric characters per unit area and/or as the number of predefined geometric patterns per unit area. The visual density can also be defined, at least partially, according to physiological criteria (model of the pilot's reading speed, etc).

The invention can also be implemented on or for different display screens, in particular flight bags EFB, ANF, ground stations TP and tablet.

The present invention may be implemented on the basis of hardware and/or software elements. It may be available as a computer program product on a computer readable medium. The medium may be electronic, magnetic, optical or electromagnetic. Some of the computing resources or means may be distributed (“Cloud computing”).

1. A method implemented by computer for managing the flight of an aircraft comprising the steps consisting in:
determining a flight context of the aircraft;
selecting, as a function of the flight context determined, one or more display parameters from among predefined parameters and displaying one or more graphically selectable labels on a representation of at least one part of the flight of the aircraft, the said representation being displayed on at least one screen in the cockpit of the aircraft;
receiving indication of the selection of one or more labels and, in response to the said selection, modifying the display of the representation of at least one part of the flight of the aircraft;
the display parameters being determined by the application of display rules which are predefined and/or configurable as a function of the flight context determined, the said rules comprising display placement rules and/or display priority rules;
the display rules being determined as a function of the visual density of the displayed information destined for the pilot.

2. The method according to claim 1, the step consisting in determining the flight context comprising one or more steps from among the steps consisting in determining information associated with the state of the systems of the aircraft and/or determining information associated with the environment of the aircraft and/or in applying predefined logic rules to the said determined information.

3. The method according to claim 1, the step consisting in determining the flight context comprising the step consisting in receiving or detecting one or more events chosen from among a sequencing of flight plan points, a change of active leg, a revision of the flight plan, the introduction of a hold command or the reception of an air traffic control clearance.

4. The method according to claim 1, the flight context being declared by the pilot.

5. The method according to claim 1, the flight context being determined repeatedly over time.

6. The method according to claim 1, further comprising the step consisting in providing a link to a documentary resource in relation to a selected label.

7. The method according to claim 6, further comprising the step consisting in displaying the said documentary resource.

8. The method according to claim 1, the display parameters being configurable.

9. The method according to claim 8, the display parameters being configured by the pilot or the airline.

10. The method according to claim 1, the representation of at least one part of the flight of the aircraft being three-dimensional.

11. The method according to claim 1, a part of the flight of the aircraft corresponding to a flight phase or to a leg.

12. A computer program product, comprising code instructions making it possible to perform the steps of the method according to claim 1, when the said program is executed on a computer.

13. A system comprising means for implementing the steps of the method according to claim 1.

14. The system according to claim 13, comprising at least one display screen of a flight management system FMS, chosen from among a PFD flight screen and/or an ND/VD navigation screen and/or an MFD multifunction screen.

15. The system according to claim 13, comprising a display screen of an Electronic Flight Bag.

16. The system according to claim 13, comprising augmented reality and/or virtual reality means.

17. The system according to claim 13, comprising means for acquiring images of the cockpit and/or a device for tracking the gaze of the pilot.
